(19) United States
(12) Patent Application Publication
(10) Pub. No.: US 2022/0257985 A1
(43) Pub. Date: Aug. 18, 2022

(54) HARNESSES

(71) Applicant: TREEMAGINEERS LTD, Pitlochry Perth and Kinross (GB)

(72) Inventors: Christopher COWELL, Pitlochry Perth and Kinross (GB); Elliot TANNER, Montgomery Powys (GB)

(21) Appl. No.: 17/628,270

(22) PCT Filed: Jul. 13, 2020
(86) PCT No.: PCT/GB2020/051689

§ 371 Date: Jan. 19, 2022

(30) Foreign Application Priority Data
Jul. 19, 2019 (GB) 1910394.4

(51) Int. Cl. A62B 35/00; A44B 11/18; A44B 11/04

(52) U.S. Cl. CPC A62B 35/0025; A44B 11/04; A44B 11/18

(57) ABSTRACT

A harness including a waist belt to which two side attachment arrangements are connected; two forward attachment arrangements. A respective riser extends between each forward attachment arrangement and one corresponding side attachment arrangement. Each side attachment arrangement includes a securing component, typically in the form of a standing ring and a lying ring assembly. The securing component is connected to the waist belt, and the lying ring assembly is held by the securing component against the waist belt. The lying ring assembly includes a retention component that, in use, passes through a loop or an eye in the riser to connect the riser to the lying ring assembly. The retention component is removable from the lying ring assembly to release the connection between the riser and the lying ring assembly.

### CROSS-REFERENCE RELATED TO PRIOR APPLICATIONS

This application is the U.S. national phase of International Application No. PCT/GB2020/051689 filed Jul. 13, 2020 which designated the U.S. and claims priority to GB Patent Application No. 1910394.4 filed Jul. 19, 2019, the entire contents of each of which are hereby incorporated by reference.

### BACKGROUND OF THE INVENTION

### Field of the Invention

This invention relates to harnesses. Particularly, but not exclusively, it relates to harnesses intended to act as a supporting harness for a person working at height or a fall-prevention harness.

### Description of the Related Art

A harness is typically constructed from multiple fabric components interconnected by metal hardware. During use, it is common for fabric components to become worn to the extent that they their safety and integrity of the harness is not maintained. However, the fabric components do not all wear at the same rate, with some components reaching the end of their safe and useful life while many other components are still serviceable. When this happens, it is advantageous if the worn components can be replaced to extend the useful working life of the harness.

One particular arrangement of harness, such as that shown in FIG. 1, has a pair of side attachment arrangements 10 each of which serves to connect a respective riser webbing 12 to a waist belt 14 of the harness. The riser webbings 12 are load-bearing components that interconnect the waist belt 14 of the harness to a respective forward connection arrangement 18, which is, in turn, connected to a respective leg loop 16. A rope bridge 20 interconnects the forward connection arrangements 18, the rope bridge 20 being the component that connects the harness to an external support, such as a climbing rope, for example through a connecting ring 22. In such a harness, it is often the case that the riser webbings 12 wear before other components because their position on the harness exposes them to abrasion, wear from continual movement or accidental damage therefore it is common for the riser webbings 12 to be replaced to prolong the working safe life of the harness.

In the harness of FIG. 1, each side attachment arrangement 10 includes two annular metal rings 24, 26 (respectively a standing ring and a lying ring), which sit against each other and the waist belt 14 to create the side attachment arrangement 10 and an attachment for the riser webbing 12. A sewn loop is formed in the riser webbing 12 through which the lying ring 26 passes. A belt webbing 30 extends around the waist belt 14. A loop of the belt webbing 30 is displaced through the lying ring 26 and passes through the standing ring 24 whereby the standing ring 24 is held by the belt webbing 30 against the lying ring 26. Thus, the standing ring acts 24 as a securing component for the lying ring 26. During use of the harness, the standing ring moves on the lying ring, with a substantial portion of the movement being rotation about a centre axis of the lying ring. Although this arrangement is functional, replacement of a riser webbing 12 requires the old webbing to be cut from the lying ring 26 and the new webbing to be sewn to the lying ring in situ on the harness or additional components to be added to the harness.

### SUMMARY OF THE INVENTION

An aim of this invention is to provide a harness in which components that are liable to wear or damage are more easily replaced than in an existing harness.

To this end, this invention provides a harness comprising a waist belt to which two side attachment arrangements are connected; two forward attachment arrangements; and a respective riser extending between each forward attachment arrangement and one corresponding side attachment arrangement; wherein each side attachment arrangement includes a securing component and a lying ring assembly, the securing component being connected to the waist belt, and the lying ring assembly being held by the securing component against the waist belt, in which the lying ring assembly includes a retention component that, in use, passes through a loop or an eye in the riser to connect the riser to the lying ring assembly, which retention component is removable from the lying ring assembly to release the connection between the riser and the lying ring assembly.

Thus, replacement of the riser can be achieved by removal and replacement of the retention component without having to cut to form the loop on the riser in situ on the harness. That is, a replacement riser can be formed under controlled (e.g., factory) conditions and fitted to the harness in a simple mechanical operation, rather than having to have a loop formed as part of the installation process. Making replacement of the riser webbing simple, and avoiding the need for special tools, increases the likelihood that the replacement will be carried out safely.

In typical embodiments, the securing component is a ring through which pass one or more connecting elements that connect the securing component to the waist belt. Alternatively, the securing component may include a portion that is shaped generally as a disc and includes passages through which pass one or more connecting elements that connect the securing component to the waist belt Many further alternative shapes and configurations of securing component are possible that meet the requirements that they can be retained on the back of the harness and that they can secure the lying ring assembly.

Where the securing component is a ring, it can be used as a point of attachment to the harness; this may not be possible where it takes other forms, such as a disc. To address this, the securing component may include one or more attachment formations to which an additional component can be connected. For example, these may include one or more lugs to which a component can be connected, e.g., by an axle bolt.

The riser is typically formed from webbing but might alternatively be formed of other elongate tension member such as a rope.

The retention component may be an axle that has a threaded portion that can be located by a threaded component, such as a nut or screw, within a bore of another component of the lying ring assembly. This allows the retention component to be installed as part of or removed from the lying ring assembly. Advantageously, the lying ring assembly further includes secondary retention means that serves to retain the retention component in place in the lying ring assembly in the absence of the threaded component. The retention component is preferably shaped such that when assembled as a component of the lying ring assembly, rotation of the retention component is prevented. This facilitates application of a threaded component to the retention component.

Advantageously, one or more preferably removable friction-reducing components may be disposed between the lying ring assembly and the standing ring. The friction-reducing components may protect the standing ring and the lying ring assembly from wear. A friction-reducing component may be provided on one or both of the lying ring component and the securing component and are preferably replaceable components.

The lying ring assembly may include one or more load-bearing attachment points by means of which items can be connected to the harness. For example, one or more attachment point may be formed by a rib that extends peripherally part-way around the lying ring assembly to define a slot through which a connection component, such as a cord, line or webbing can be passed. The attachment points can be used, for example, to connect the harness to an upper body harness e.g., for fall protection or as a point to which items to be carried, such as tools or accessories, can be secured.

It will be appreciated that alternative configurations of side attachment arrangements are described. There is no requirement that a harness embodying the invention has two identical (or mirror-image) side attachment arrangements. These may be different from one side of the harness to the other.

### BRIEF DESCRIPTION OF THE DRAWINGS

Embodiments of the invention will now be described in detail, by way of example, with reference to the accompanying drawings, in which:

FIG. 1 shows a known harness of a type that to which the present invention can be applied;

FIG. 2 shows assembled components of a side attachment arrangement of a harness embodying the invention;

FIG. 3 is an exploded view of the arrangement of FIG. 2;

FIG. 4 is a cross-sectional view of the arrangement of FIG. 2 secured in place on a harness;

FIG. 5 shows the arrangement of FIG. 2 connected to a riser webbing;

FIG. 6 is an exploded diagram corresponding to that of FIG. 5;

FIGS. 7 and 8 show how the riser webbing can pivot with respect to the side attachment arrangement;

FIG. 9 shows how a lying ring of the side attachment arrangement can pivot with respect to a standing ring of the side attachment arrangement;

FIGS. 10 and 11 show connections made to an external loading slot of a lying ring body of the side attachment arrangement;

FIG. 12 shows in more detail a first lug of the side attachment arrangement with the head of an axle component;

FIGS. 13 and 14 show variations to the side attachment arrangement of the preceding figures that incorporate a wear interface

FIG. 15 shows components of a first alternative side attachment arrangement for use in embodiments of the invention

FIG. 16 is a cross-section through the components of FIG. 15; and

FIGS. 17 and 18 show a components of a second alternative side attachment arrangement for use in embodiments of the invention.

### DESCRIPTION OF THE PREFERRED EMBODIMENTS

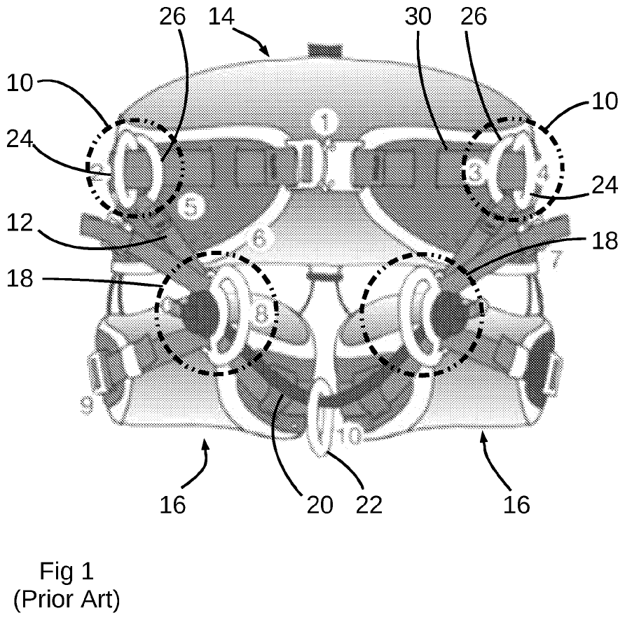

With reference to the drawings, a harness embodying the invention is a modification of the harness of FIG. 1. The side attachment arrangements 100 shown in the drawings each replace a respective one of the side attachment arrangements 10.

Each side attachment arrangement 100 includes a securing component which, in this embodiment, is a standing ring 24, the same as that shown in the harness of FIG. 1. The arrangement further includes a lying ring assembly 126.

The lying ring assembly 126 is comprises a lying ring body 140 that is a one-piece metal component. The lying ring body 140 has an annular portion that has a circular central aperture 142 in a plane P of the lying ring body. The aperture 142 that has a diameter less than the outer diameter of the standing ring 24, such that the standing ring 24 cannot pass through the aperture. The material of the lying ring body 140 that defines the periphery of the aperture 142 is radiused.

The lying ring body 140 includes a yoke portion, which is formed by first and second projecting lugs 144, 146. The lugs 144, 146 have mutually facing flat surfaces that extend in a direction normal to the plane P. A bore extends through each lug parallel to the plane P, the bores of the two lugs being coaxial.

The lying ring assembly 126 further comprises a one-piece metal axle 150. The axle 150 has an elongate cylindrical shaft portion 152 with a head portion 154 at one end of diameter greater than that of the shaft portion 152. The head portion 154 has a radially-extending fork portion 156. An axial tapped bore is formed into the end of the shaft portion 152 opposite the head portion 154.

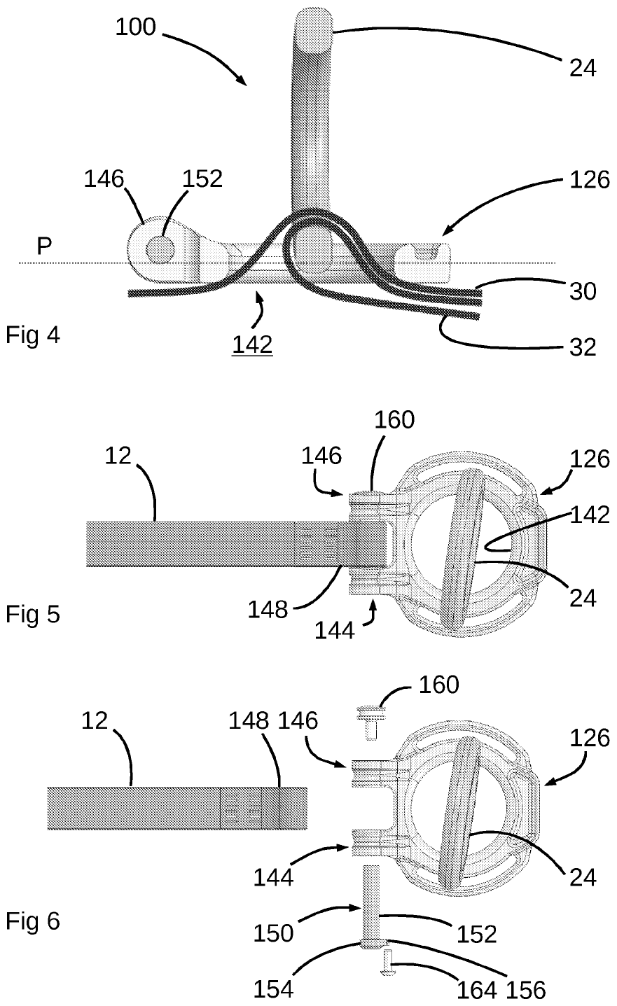

Each side attachment assembly is installed on a harness by threading the belt webbing 30 and additional harness webbing 32 through the aperture of the lying ring body 140, through the standing ring 24, and then back through the aperture of the aperture of the lying ring body 140, as shown in FIG. 4. When the belt webbing 30 is tightened, the side attachment arrangement 10 is secured on the waist belt 14.

The riser webbing 12 can be connected to the side attachment arrangement 10 by placing its sewn end loop 148 between the lugs 144, 146 then passing the shaft portion 152 of the axle 150 through the bore in the first lug 144, through the end loop 148 of the riser webbing 12, then into the bore of the second lug 146. With the axle 150 in this operational position, the riser webbing 12 is securely connected to the lying ring assembly 126, and thus to the waist belt 14.

Features are present in the lying ring assembly 126 that serve to enhance the location of the axle 150 on the lying ring body 140.

A threaded axle cap screw 160 has a threaded shaft that is passed though the aperture in the second lug 146 to be received in the tapped bore in the end of the shaft portion 152 of the axle 150. A recess is formed axially into a head of the cap screw, the recess being shaped (for example, with a hexagonal cross-section) to receive a tool that can be used to rotate the screw 160. The head of the axle cap screw 160 is received within a recess of the second lug 146. An O-ring (not shown) is carried on the axle 150, positioned to make frictional contact with the bore of the first or the second lug 144, 146 when the axle is in the operational position, and thereby inhibit rotational movement of the screw 160 which could result in its release from the axle 150.

The presence of the axle cap screw 160 prevents the axle 150 from sliding from the bores. A recess is formed in the first lug 144 into which the head portion 154 is received. The recess is shaped to conform closely to the shape of the head portion 154, the presence of the fork portion 156 preventing the axle 150 rotating in the bores when the axle cap screw 160 is being tightened into place. Within the recess in the first lug 144 there is a tapped hole 162. With the axle 150 secured in place by the axle cap bolt 160, an axle bolt 164 can be screwed into the tapped hole 162, a head of the axle bolt 164 bearing against the fork portion 156 of the axle. This serves as a supplementary mechanism for retaining the axle 150 in place in the lying ring body 140 in case of failure or loss of the axle cap screw 160.

It will be seen that disconnection of the riser webbing 12 can be achieved by removing the axle bolt 164 and the axle cap screw 160 and withdrawing the axle 150 from the lying ring body 140. A replacement riser webbing 12 can then be installed as described above.

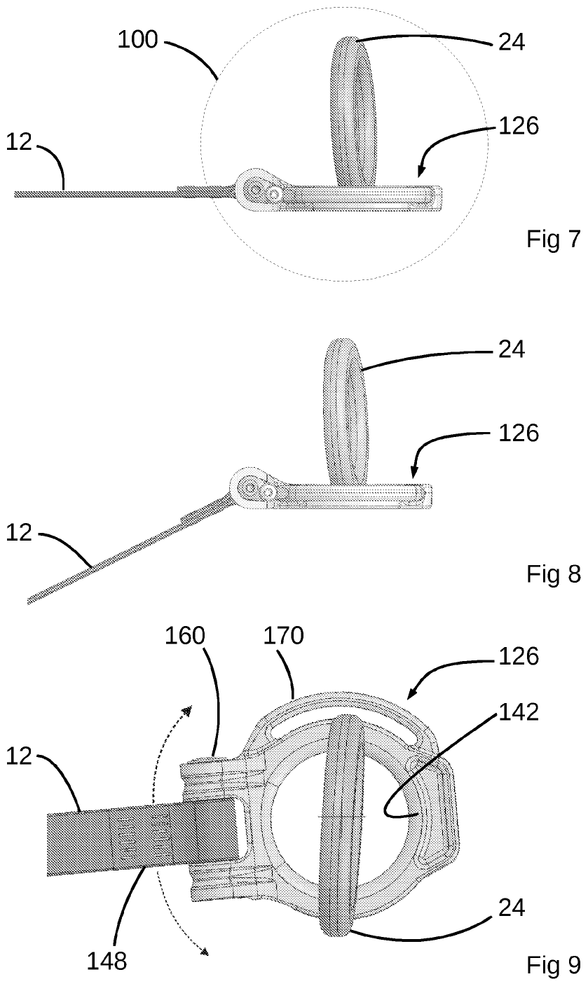

As a wearer of the harness moves, the riser webbings 12 move with respect to the side attachment arrangements 10. To avoid wear and to minimise incumbrance upon the wearer, it is advantageous that such movement can take place with minimal resistance. As will be seen from FIGS. 7 and 8, the riser webbing 12 can pivot with respect to the lying ring body 140 about the axis of the axle 150. As shown in FIG. 9, the lying ring body 140 and the riser webbing 12 attached to it can also pivot about the standing ring 24 about an axis centred on the aperture of the lying ring body 140 since the lying ring body 140 is free to rotate concentrically with respect to the contact points of the standing ring 24, and therefore also with respect to the waist belt webbing 30 to which it is fixed.

One, two or more perimeter ribs 170, 172 extend partially around the periphery of the lying ring body 140 such that each rib 170, 172 defines an arcuate slot that extends through the lying ring body 140 radially outwardly from the central aperture 142. The arcuate slots can serve as load-bearing attachment points with which items can be attached to the harness, typically by passing webbing 174, a line or cord through one or both slots. For example, they may serve as connection points for an upper harness assembly for fall protection or as a loading or support point to retain tools or accessories. A lying ring body 140 with one rib and slot may be less versatile than one with two, but it will be lighter and occupy less space on the harness. The arcuate slots are concentric to the rotation axis of the lying ring body 140, an arrangement that minimises rotational load applied to the side attachment arrangement 10.

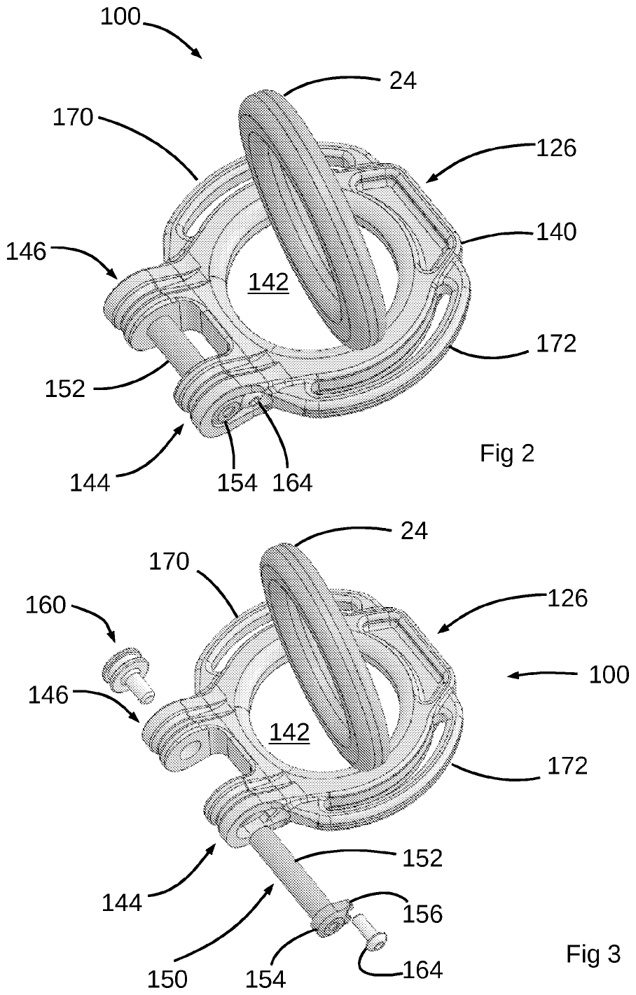

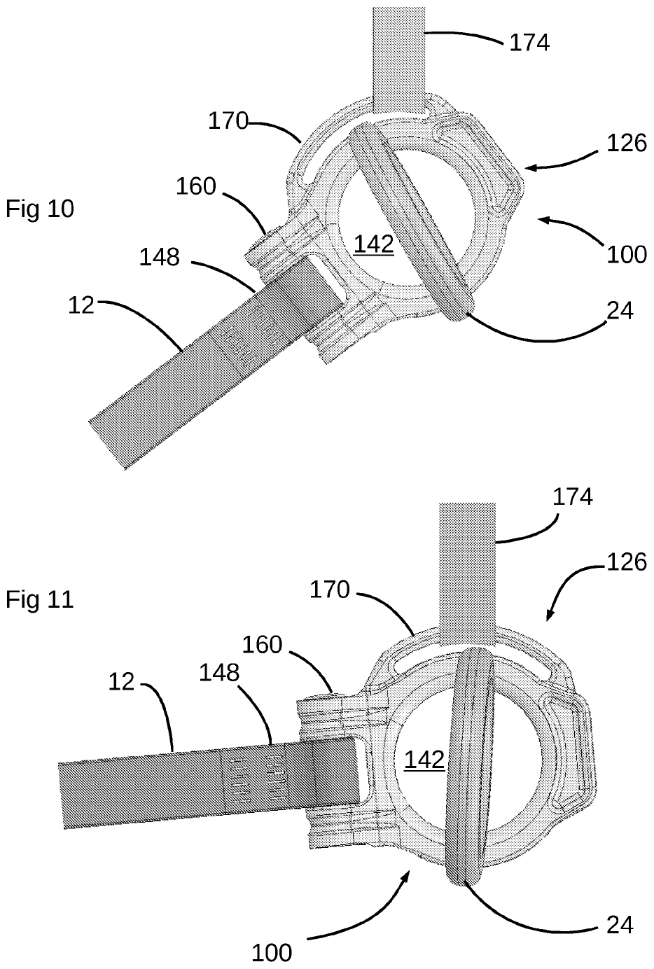

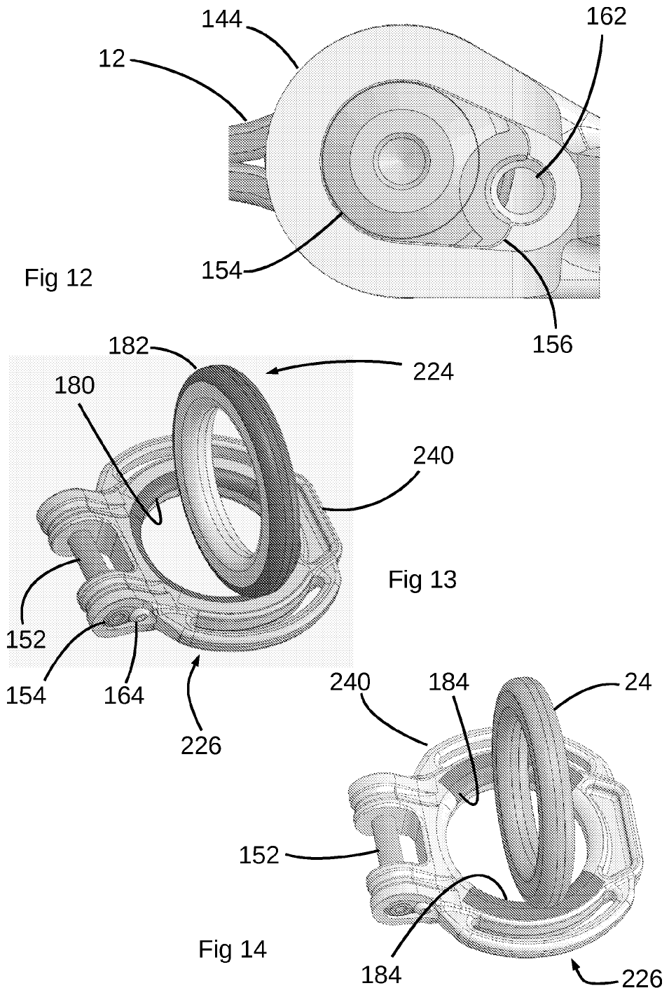

While the harness is in use, the standing ring 24 is in continual movement with respect to the lying ring body 140, with friction and potential wear occurring where these two components are in contact with one another. To mitigate such wear, low-friction components may be applied to either or both of the standing ring 224 and the lying ring body 240. As shown in FIG. 13, a low-friction component 180 may extend entirely around the aperture of the lying ring body 240, or, as in FIG. 14, low-friction components 184 may be provided only in those areas subject to the greatest wear. FIG. 13 shows a low-friction component 182 applied also to the standing ring 224 (in which case, the lying ring body 140 may optionally be in accordance with that described in relation to FIGS. 1 to 12). The arrangement of FIG. 14 uses a simple standing ring 24 as shown in FIGS. 1 to 12. In either case, the low-friction components are preferably configured to be replaceable by a user when they become worn to excess.

It will be seen that in embodiments described above, the essential function of the standing ring 24 is to retain the lying ring body 140, and therefore the side attachment arrangement 10 as a whole, in place on the waist belt 14; its ability to act as a connection point for other components is a secondary and optional function. Therefore, it is possible to use components other than a ring to serve as a retention component in alternative configurations.

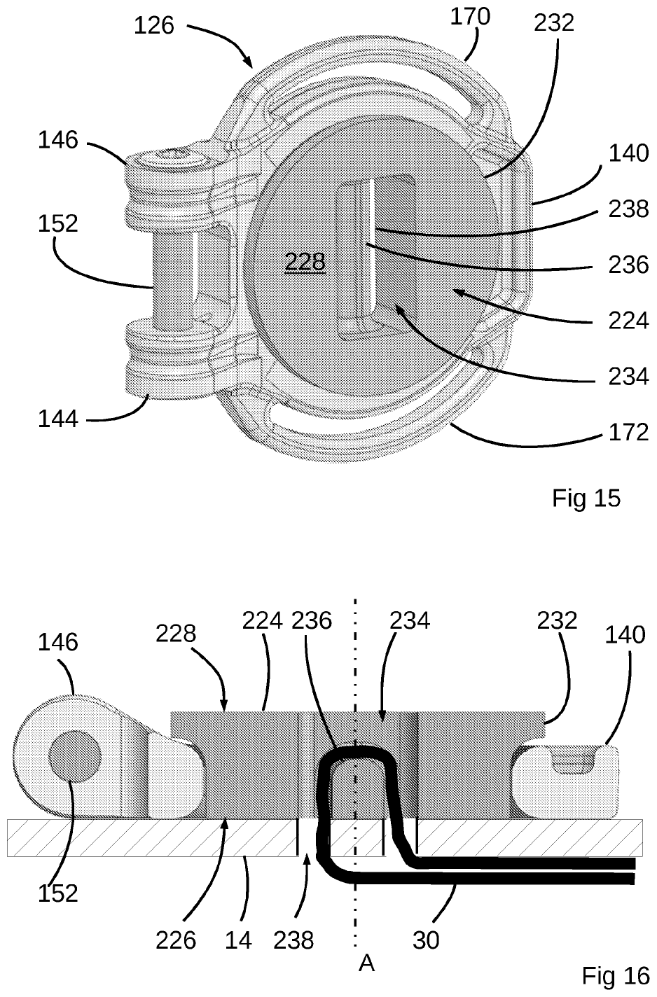

FIGS. 15 and 16 show an alternative side attachment arrangement, which includes a lying ring assembly 126 similar to that of the preceding embodiments. Instead of a standing ring 24, a securing component is in the form of a metal disc 224. The disc 224 has an inner surface 226 and an outer surface 228 and is centred upon an axis A. Along most of the axis A, the disc 224 has a diameter that makes it a close fit within the aperture 142 of the lying ring body 140. A flange 232 projects radially from a portion of the disc close to the outer surface 226, an interface region between the flange 232 and the rest of the disc 224 being radiused. The disc 224 enters into the aperture 142, but the flange 232 prevents it from passing through the aperture 142.

A rectangular through passage 234 passes centrally through the disc 224 interconnecting the inner and outer surfaces 226, 228. A dividing bar 236 extends between opposite short end walls of the through passage 234, and from the inner surface 228 approximately half-way to the outer surface 228, the dividing bar 236 having a radiused surface facing in the direction of the outer surface 228. The dividing bar 236 effectively splits the through passage 234 into two webbing slots 238 at the inner surface 226, which can be seen in FIG. 18.

Referring to FIG. 4, it will be seen that, in an assembled harness, two (typically—it may be more or fewer) webbings 30, 32 pass into the aperture 142 of the lying ring body 140 and through the standing ring 24. In this embodiment, these webbings 30, 32 pass into the aperture 142 of the lying ring body 140 and through the webbing slots 238 into the through passage 234, looping over the dividing bar 236. Tension in the webbings 30, 32 pulls the disc 224 towards the waist belt 14, the flange 232 acting to the lying ring body 140 in close proximity to the waist belt 14, as in FIG. 16 (just one webbing 30 being shown for clarity).

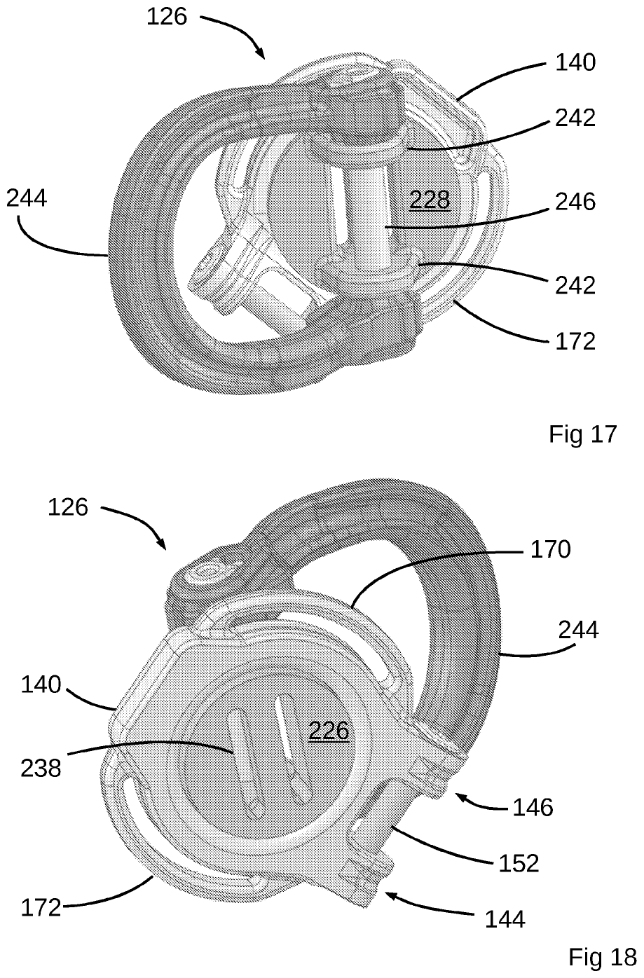

In the embodiment of FIGS. 15 and 16, the outer surface 228 of the disc 224 is flat. This has the advantage of reducing the bulk of the harness and incumbrance to a user but removes the secondary function of the standing ring 24 as a component to which a connection can be made. In order to address this, the securing component 224 can be modified to provide attachment formations on its outer surface 228. An example of such formations is shown in FIGS. 17 and 18, in which they take the form of lugs 242 to which a component, such as a shackle 244, can be connected using, in this example, an axle bolt 246.

1. A harness comprising:
a waist belt to which two side attachment arrangements are connected;
two forward attachment arrangements; and
a respective riser extending between each forward attachment arrangement and one corresponding side attachment arrangement;
wherein each side attachment arrangement includes a securing component and a lying ring assembly, the securing component being connected to the waist belt, and the lying ring assembly being held by the securing component against the waist belt, in which the lying ring assembly includes a retention component that, in use, passes through a loop or an eye in the riser to connect the riser to the lying ring assembly, which retention component is removable from the lying ring assembly to release the connection between the riser and the lying ring assembly.

2. The harness of claim 1, wherein the securing component is a ring through which pass one or more connecting elements that connect the securing component to the waist belt.

3. The harness of claim 1, wherein the securing component includes a portion shaped generally as a disc and includes passages through which pass one or more connecting elements that connect the securing component to the waist belt.

4. The harness of claim 3, wherein the securing component includes one or more attachment formations to which an additional component can be connected.

5. The harness of claim 3, wherein the attachment formations include a lug.

6. The harness of claim 1, wherein the riser is formed from webbing.

7. The harness of claim 1, wherein the retention component is an axle that has a threaded portion that can be located by a threaded component within a bore of another component of the lying ring assembly.

8. The harness of claim 7, wherein the threaded component is a screw and the threaded portion is an internally threaded bore of the axle.

9. The harness of claim 1, wherein the lying ring sembly further includes secondary retention means that serves to retain the retention component in place in the lying ring assembly in the absence of the threaded component.

10. The harness of claim 1, wherein the retention component is shaped such that when assembled as a component of the lying ring assembly, rotation of the retention component is prevented.

11. The harness of claim 1, further comprising a friction-reducing component disposed between the lying ring assembly and the securing component.

12. The harness of claim 11, wherein the friction reducing component is provided on the lying ring component.

13. The harness of claim 11, wherein the friction reducing component is provided on the securing component.

14. The harness of claim 11, wherein the friction-reducing component is a replaceable component.

15. The harness of claim 1, wherein the lying ring assembly includes one or more load-bearing attachment points by means of which items can be connected to the harness.

16. The harness of claim 15 wherein one or more attachment point is formed by a rib that extends peripherally part-way around the lying ring assembly to define a slot through which a connection component can be passed.

17. The harness of claim 1, wherein the side attachment arrangements are substantially identical to or are mirror-images of one another.

18. The harness of claim 1, wherein the side attachment arrangements are dissimilar to one another.

19. The harness of claim 2, wherein the riser is formed from webbing.

20. The harness of claim 3, wherein the riser is formed from webbing.
